(19) United States
(12) Patent Application Publication
(10) Pub. No.: US 2003/0101833 A1
(43) Pub. Date: Jun. 5, 2003

(54) Bearingless pinion with cleaning edges

(76) Inventors: Donald J. Monroe, Brighton, MI (US); Ronald Cowen, Dundee, MI (US); Wei Xue, Northville, MI (US)

Correspondence Address: BRINKS HOFER GILSON & LIONE, P. O. Box 10395, Chicago, IL, 60610, US

(21) Appl. No.: 10/004,758

(22) Filed: Dec. 4, 2001

(51) Int. Cl. F02N 1/00

(52) U.S. Cl. 74/7 R

(57) ABSTRACT

The present invention involves a starter pinion moveable along an output shaft of a starter assembly. The pinion has an inner surface disposed about the output shaft, wherein the inner surface extends to an end face of the pinion. The pinion comprises a primary edge for moving particles from the output shaft as the pinion moves along the output shaft. The primary edge is formed along a length of the inner surface and extends to the end face. The primary edge defines a groove in which the particles are received as the pinion moves along the output shaft. The groove is formed along the length of the inner surface and adjacent the primary edge.

### BACKGROUND OF THE INVENTION

The present invention relates to a bearingless pinion and method for moving particles from an output shaft of a starter assembly.

Pinion gears are known and have been widely used in many industries such as the automotive industry. For example, as known in the art, a starter pinion may be used in an engine start-up drive assembly which engages a ring gear on a flywheel to turn an engine during engine start-up. Typically, a starter pinion is made of rigid material, e.g., steel and has a bore formed therethrough defining an inner surface. A bushing or bearing typically is disposed along the inner surface to be placed about a rotatable starter output shaft along which the pinion moves during engine start-up to engage the ring gear on the flywheel. As known in the art, when a starter switch is activated, a magnetic field set up by a respective solenoid pulls a connecting rod connected with a shifting lever and pushes a clutch barrel against the pinion. This, in turn, generally moves the pinion into engagement with the ring gear on the flywheel. As long as the solenoid is held down in energized position, disengagement between the starter motor and the engine will not take place so that the latter can be started until firing.

However, it has been determined that particles may collect on the output shaft about which the pinion is disposed. During start-up, as the pinion rotatably and linearly moves along the output shaft, the particles become lodged between the bushing and the shaft. As the pinion moves along the shaft, the particles wear into the bushing which is typically made of a material, e.g., brass, less rigid than the material of the shaft, e.g., steel. In time, the wear on the bushing may result in unacceptable vibration.

Additionally, it is desired to reduce the cost of manufacturing such pinion. A typical process of making a pinion having the bushing generally may include several costly steps, e.g., manufacturing a hole through the pinion, disposing the bushing on the inner surface of the pinion, and resizing the bushing to fit thereon. This typical process has been found to result in relatively high material and labor costs which, if lessened or eliminated, would significantly reduce costs.

### BRIEF DESCRIPTION OF THE DRAWINGS

FIG. 1 is a side environmental view of a starter assembly including a pinion in accordance with a first embodiment of the present invention;

FIG. 2 is an enlarged view of area 2 of FIG. 1 depicting a pinion in accordance with a first embodiment of the present invention;

FIG. 3 is a perspective view of the pinion in FIG. 2;

FIG. 4 is a top view of the pinion in accordance with a first embodiment of the present invention;

FIG. 5 is a cross-sectional view of the pinion in FIG. 4 taken along lines 5-5;

FIG. 6 is a flow chart depicting one method of moving particles from a output shaft in accordance with the present invention;

FIG. 7 is a top view of another embodiment of the pinion in accordance with a second embodiment of the present invention; and

FIG. 8 is a cross-sectional view of the pinion in FIG. 7 taken along lines 8-8.

### DETAILED DESCRIPTION

The present invention generally provides a starter assembly having an output shaft and a starter pinion which is disposed about the output shaft. During engine startup, the starter pinion “sweeps” or moves undesired particles from the output shaft to “clean” the shaft. The pinion includes an inner surface which is disposed about the shaft and has a groove formed therealong to define primary and secondary cleaning edges. During startup, the groove and the primary cleaning edge “sweep” or move undesired particles in a primary cleaning step. Then, during a subsequent engine startup, in a secondary cleaning step, the secondary cleaning edge further move the particles along the shaft and away from the inner surface of the pinion.

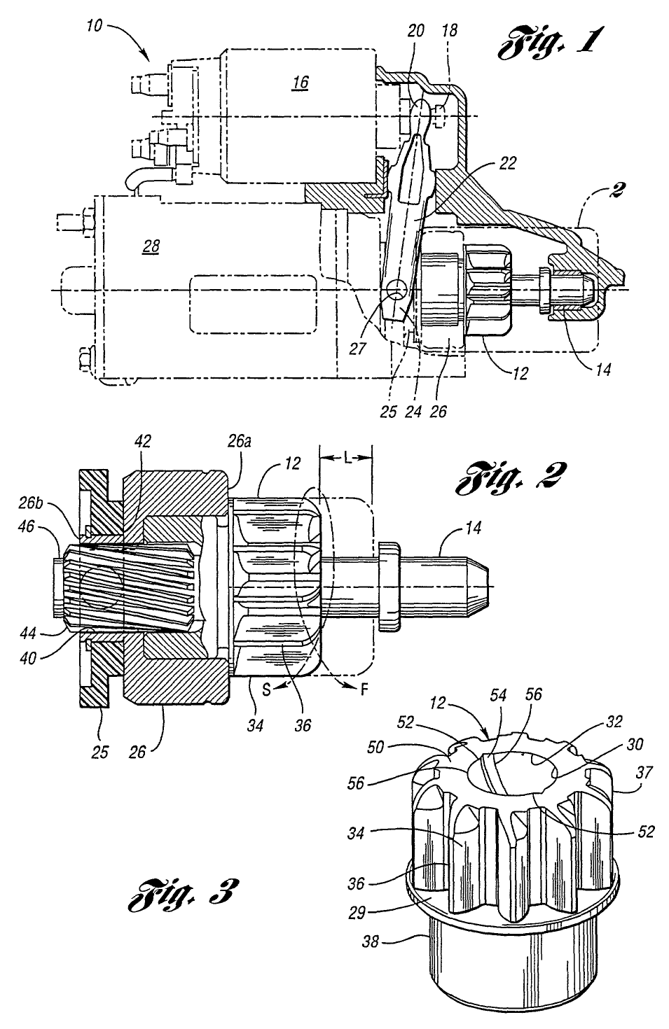

FIG. 1 illustrates a starter assembly 10 of the first embodiment having a starter or drive pinion 12 which is movable along an output shaft 14 of the starter assembly 10. In this embodiment, pinion 12 is rotatably and linearly moveable along output shaft 14 during engine startup. FIG. 1 further depicts assembly 10 generally including a solenoid switch 16 having a connecting rod 18 to which first end 20 of a shifting lever 22 is mounted. The shifting lever 22 has second end 24 which is mounted to a collar 25 attached to a barrel 26 (described below). As shown, assembly 10 further includes a starter motor 28. During startup, the solenoid pulls the shifting lever 22 toward the solenoid switch to move barrel 26 and pinion 12 along shaft 14, and closes the starter circuit to energize the motor to rotate the barrel and pinion.

During startup, pinion 12 is designed to clean shaft 14 of particles which accumulate thereon. As shown in FIGS. 1-3, pinion 12 is a one-piece pinion having teeth or gear portion 34 and race portion 38. Teeth portion 34 has a bore 30 formed therethrough forming inner surface 32 disposed about shaft 14. Teeth or gear portion 34 has flange 29 and outer surface 37 on which teeth or gears 36 are formed. Race portion 38 coaxially connects to barrel 26 as described below. Gears 36 are configured to engage a ring gear on a respective flywheel (not shown) to turn the engine during startup.

In this embodiment, barrel 26 has a pinion-receiving end 26a and a collar-receiving end 26b extending from barrel 26. The pinion-receiving end 26a connects to race portion 38 of pinion 12 and the collar-receiving end 26b includes an inside surface 40 having internal helical spline 42 thereon. As shown, collar 25 is disposed about collar-receiving end 26b opposite the pinion 12 which is inserted in pinion-receiving end 26a. Moreover, collar 25 may have a mounting member 27, e.g., a pair of mounting ears, to which the second end 24 of shifting lever 22 is mounted.

It is understood that the pinion and the barrel may be connected by any suitable means. In this embodiment, it is shown that the race portion 38 of pinion 12 inserts into pinion-receiving end 26a of the barrel 26 for attachment thereto. Of course, any other suitable means of connecting the pinion and the barrel 26 does not fall beyond the scope or spirit of the present invention.

As shown in FIG. 2, an external helical spline 44 is formed about the output shaft 14 adjacent an end 46 thereof. The internal helical spline 42 complements the external helical spline 44 so that the pinion 12 moves along shaft 14 during startup. In this embodiment, the external helical spline 44 is preferably but not necessarily threaded spirally in a direction opposite to the rotation of the starter motor 28 in operation. In operation, the internal helical spline 42 complements and engages the external helical spline 44 when the output shaft 14 is turned. Generally, during startup when the solenoid switch is energized by the starter motor, the lever is pulled toward the solenoid which, in turn, moves the barrel and pinion rotationally and linearly along the shaft.

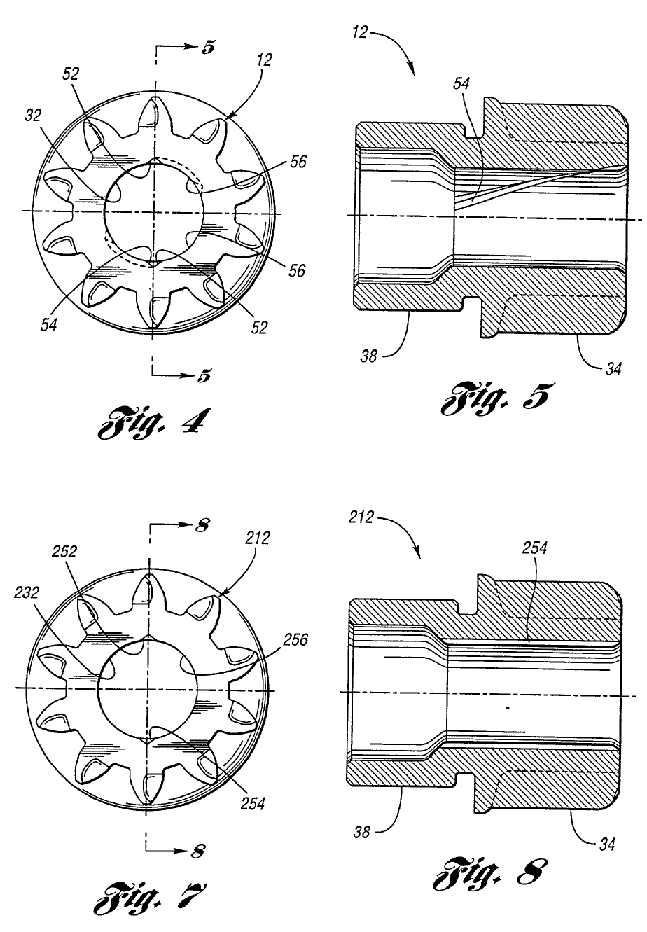

FIG. 3 illustrates teeth portion 34 of pinion 12 having inner surface 32 disposed about output shaft 14 wherein inner surface 32 extends to end face 50 of pinion 12. FIGS. 3 and 4 depict primary edges 52 and groove 54 which move particles from the output shaft 14 as pinion 12 rotatably and linearly moves therealong. As shown, each primary edge 52 comprises a side or wall which form respective groove 54. As pinion 12 moves along output shaft 14, one primary edge is formed adjacent another primary edge to define the groove in which particles are received. Primary edges 52 and groove 54 are formed along a length of inner surface 32 and extend to end face 50. In this embodiment, primary edges 52 and groove 54 are formed arcuately or helically along the length of inner surface 32. Of course, primary edges 52 and groove 54 may take on any other suitable shape along the length of inner surface 32. For example, primary edge 52 and groove 54 may be substantially linearly formed along inner surface 32. In this embodiment, the length along which the primary edges 52 and groove 54 are formed includes the entire length of inner surface 32. Of course, the length along which the primary edges and the groove are formed may include a portion of the length of inner surface 32.

As shown in FIGS. 3 and 4, pinion 12 further includes a plurality of secondary edges 56 radially formed along end face 50. As shown in FIGS. 4 and 5, each secondary edge 56 integrally connects to a respective primary edge 52 at end face 50. Secondary edge 56 then radially extends on end face 50. As described in greater detail below, secondary edge 56 further or secondarily cleans or moves particles along shaft 14.

Upon engine startup, particles, e.g., dust or rust, which accumulate on shaft 14 are moved therefrom when the particles are contacted/removed by primary edges 52 and at least partially received in groove 54. Generally, primary edges 52 rotatably and linearly move particles received in groove 54 along the output shaft 14 as pinion 12 rotatably and linearly moves along output shaft 14. As primary edge 52 and groove 54 move along shaft 14, more particles are accumulated in groove 54 and “swept” or moved along shaft 14. Movement of the particles is defined by movement of primary edges 52 and groove 54 which contains accumulated particles therein. The typical rotational and linear movement of pinion 12 along shaft 14 causes primary edges 52 and groove 54 to rotationally and linearly move therealong.

Preferably but not necessarily, a plurality of grooves 54, e.g., two grooves, is formed on the inner surface to cover or “sweep” the circumference thereof. However, it is understood that either one or a plurality of grooves 54 may be formed on the inner surface of the pinion without falling beyond the scope or spirit of the present invention. As shown in FIG. 4, two grooves 54 are formed along inner surface 32 of pinion 12. As shown in FIGS. 4 and 5, in this first embodiment, primary edges 52 and groove 54 are arcuately formed along inner surface 32 of pinion 12. It has been found that a curved or arcuate formation of primary edges 52 and groove 54 allow an efficient cleaning or moving of particles which may accumulate along shaft 14. The arcuate formation of primary edges 52 along inner surface 32 allows for an adequate area “cleaning” or moving of particles along shaft 14 than a substantially linear formation thereof.

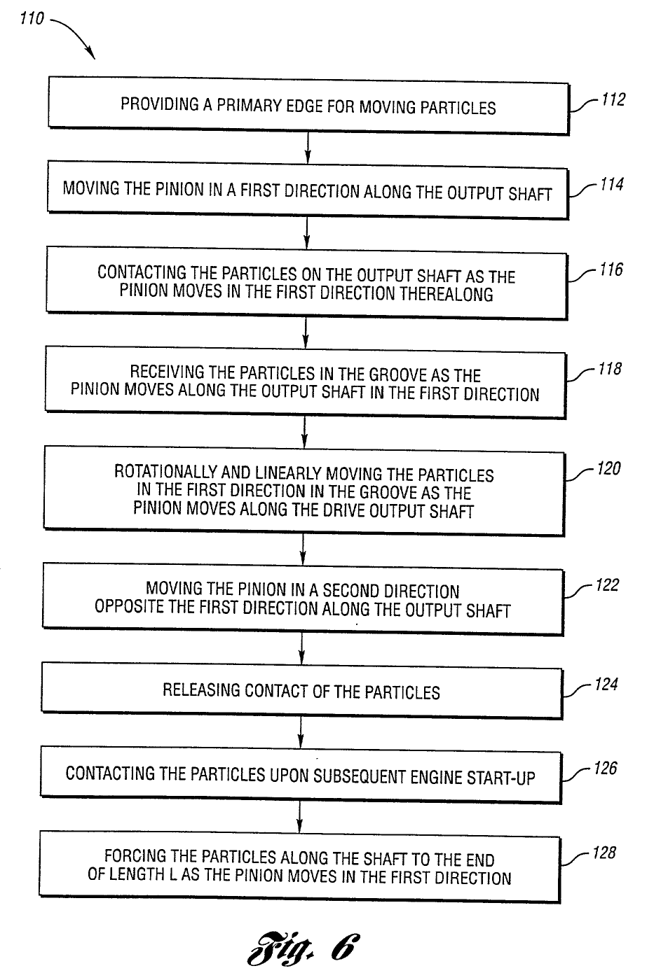

As shown in FIG. 6, the present invention also includes a method 110 of moving particles from an output shaft with a starter pinion of a drive assembly during engine start-up. The pinion, as described above, rotatably and linearly moves along the output shaft during engine start-up. As the pinion moves along the shaft, the pinion receives and moves particles on the output shaft. Method 110 of moving particles from the output shaft comprises providing the pinion in box 112 as described above and moving the pinion in a first direction F along the output shaft in box 114. The first direction F includes rotational and linear movements or a helical movement along the output shaft as depicted in FIG. 2.

In FIG. 2, the linear distance is represented by a predetermined distance, length L. It is to be noted that length L may depend on the starter assembly and the engine for which the pinion is used. For example, length L could range between about 10 and 20 millimeters. However, other ranges and lengths would not fall beyond the scope or spirit of the present invention.

Rotational movement of the pinion depends on the angle formed on the external and internal helical splines (described above) on which the pinion rides. As the pinion moves along the output shaft in the first direction F, the primary edge contacts the particles in box 116. Some particles on the shaft will be removed by secondary edges and some particles are received in the groove in box 118. In the first direction F, the primary edges rotationally and linearly move or force the particles within the groove as the pinion moves along the output shaft in box 120. As the particles are moved in the first direction F within the groove, the particles accumulate in the groove. The accumulated particles move and travel through the groove in the first direction F toward the end face. During engine startup, some of the particles exit the groove through the end face, and some particles remain within the groove. At start-up, the pinion engages a ring gear which is connected to a flywheel, as known in the art, to crank the engine. As engine start-up terminates, the pinion disengages with the ring gear and moves in a second direction S opposite the first direction F along the output shaft in box 122. It is to be noted that second direction S may include merely a linear movement for the distance of length L opposite first direction F without falling beyond the scope or spirit of the present invention. Upon termination of start-up, particles which remain on the shaft and along length L are no longer received within the groove, due to the movement of the pinion in the second direction. Thus, as the pinion moves in the second direction, contact of the primary edges with particles remaining along length L is released in box 124. This may be termed “primary cleaning” to clean or move the particles from an area on the shaft where particles could otherwise be wedged between the shaft and the inner surface, potentially causing starter assembly failure.

Upon a subsequent engine startup, the secondary edges contact the accumulated particles remaining along length L and further force or move the particles along the shaft to the end of length L as the pinion moves in the first direction F along the shaft in box 126. This is termed “secondary cleaning” to further clean or force the particles to the end of length L along the shaft. After the secondary cleaning, the particles eventually release contact and disengage from the shaft.

FIGS. 7 and 8 depict another embodiment of a pinion in accordance with the present invention. As shown in FIGS. 7 and 8, starter pinion 212 has similar members as pinion 12 described above. For example, inner surface 32, end face 50, gears 36, and outer surface 37 of starter pinion 12 are similar to inner surface 232, end face 250, gears 236, and outer surface 237, respectively, of starter pinion 212. In this embodiment, primary edges 252 and groove 254 are shown to be substantially linear. As shown, secondary edge 254 integrally connects with primary edge 252 and radially extends along end face 250. As in the embodiment described above, pinion 212 is configured to rotatably and linearly move along a respective output shaft during engine startup. It is to be noted that the pinion described above may include any other starter pinion for any suitable engine or starter assembly having one or a plurality of pinions without falling beyond the scope or spirit of the present invention.

1. A pinion moveable along a output shaft of a starter assembly, the pinion having an inner surface disposed about the output shaft, the inner surface extending to an end face of the pinion, the pinion comprising:
a primary edge for moving particles from the shaft as the pinion moves along the output shaft, the primary edge being formed along a length of the inner surface and extending to the end face, the primary edge defining a groove in which the particles are received as the pinion moves along the output shaft, the groove being formed along the length of the inner surface and adjacent a primary edge.

2. The starter pinion of claim 1 wherein the pinion is a one-piece pinion.

3. The starter pinion of claim 1 wherein the pinion is rotatably and linearly moveable along the output shaft.

4. The starter pinion of claim 1 wherein the output shaft is rotatable.

5. The starter pinion of claim 1 further comprising a secondary edge for moving the particles from the primary edge, the secondary edge being radially formed on the end face adjacent the primary edge.

6. The starter pinion of claim 1 wherein the primary edge moves particles from a portion on the output shaft as the pinion moves along the output shaft.

7. The starter pinion of claim 1 wherein the primary edge is arcuately formed along the inner surface of the pinion.

8. The starter pinion of claim 1 wherein the primary edge is formed essentially linear on the inner surface of the pinion.

9. The starter pinion of claim 1 wherein the inner surface has a plurality of primary edges formed thereon.

10. The starter pinion of claim 9 wherein the inner surface includes a plurality of grooves, each groove being formed along the length of the inner surface and adjacent each respective primary edge.

11. The starter pinion of claim 1 wherein the length along which the primary edge is formed includes the entire length of the inner surface.

12. The starter pinion of claim 1 wherein the length along which the primary edge is formed includes a portion of the length of the inner surface.

13. The starter pinion of claim 1 wherein the starter pinion is made of a metal.

14. The starter pinion of claim 1 wherein the pinion includes a barrel portion and a gear portion, the end face and the inner surface being adjacent the gear portion.

15. A starter pinion moveable along an output shaft of a starter assembly, the pinion comprising:
an inner surface having a bore formed therethrough, the inner surface being disposed about the output shaft and extending to an end face of the pinion; and
a groove for receiving and moving particles along the output shaft as the pinion moves along the output shaft, the groove being formed along a length of the inner surface and extending to the end face, the groove defining a primary cleaning edge formed adjacent the groove along the length of the inner surface so.

16. The starter pinion of claim 15 further comprising a secondary edge for moving the particles from the primary edge, the secondary edge being radially formed on the end face adjacent the primary edge.

17. The starter pinion of claim 15 wherein the groove is arcuately formed along the inner surface of the pinion to receive and move particles from a portion on the output shaft as the pinion moves therealong.

18. The starter pinion of claim 15 wherein the groove is formed essentially linear on the inner surface of the pinion to receive and move particles from a portion on the output shaft as the pinion moves therealong.

19. The starter pinion of claim 15 wherein the inner surface has a plurality of grooves formed thereon.

20. The starter pinion of claim 15 wherein each groove is formed along the length of the inner surface and adjacent each primary edge.

21. The starter pinion of claim 15 wherein the length along which the groove is formed includes the entire length of the inner surface.

22. A starter assembly for startup of an engine, the assembly comprising:
a starter motor to provide power to the starter assembly;
an output shaft rotatably attached to the motor and powered thereby to rotate the shaft, the shaft having an external helical spline formed thereabout;
a starter pinion being moveable along the output shaft, the pinion having a teeth portion on which teeth are formed about an outer surface of the pinion and a race portion attached to the teeth portion, the teeth portion having a bore formed therethrough defining an inner surface of the teeth portion, the inner surface being disposed about the output shaft, the inner surface extending to an end face of the pinion, the inner surface having a groove for receiving and removing particles along the output shaft when the pinion moves therealong, the groove being formed along a length of the inner surface to the end face defining a primary cleaning edge formed adjacent the groove along the length of the inner surface;
a barrel having a pinion-receiving end and a collar-receiving end, the pinion-receiving end connecting to the race portion of the pinion, the collar-receiving end oppositely extending from the barrel and including an inside surface having a internal helical spline formed thereon, the internal helical spline complementing the external helical spline and engaged therewith, the barrel including a collar disposed about the collar-receiving end and having a mounting member; and
a solenoid switch including a connecting rod and a shifting lever having first and second ends, the first end attaching to the connecting rod, the second end attaching to the mounting member, the solenoid switch being configured to power the starter motor during engine startup after pulling the end of the shifting lever toward the solenoid switch and moving the pinion along the shaft.

23. The starter pinion of claim 22 further comprising a secondary edge for moving the particles from the primary edge, the secondary edge being radially formed on the end face adjacent the primary edge.

24. The starter pinion of claim 22 wherein the groove is arcuately formed along the inner surface of the pinion to receive and move particles from a portion on the output shaft as the pinion moves therealong.

25. The starter pinion of claim 22 wherein the groove is formed essentially linear on the inner surface of the pinion to receive and move particles from a portion on the output shaft as the pinion moves therealong.

26. The starter pinion of claim 22 wherein the inner surface has a plurality of grooves formed thereon.

27. The starter pinion of claim 22 wherein each groove is formed along the length of the inner surface and adjacent each primary edge.

28. The starter pinion of claim 22 wherein the length along which the groove is formed includes the entire length of the inner surface.

29. A method of moving particles from an output shaft with a starter pinion of a drive assembly, the pinion having an inner surface disposed about the output shaft and an end face, the method comprising:
providing a primary edge and groove formed on the inner surface for moving particles from the output shaft as the pinion moves along the output shaft, the primary edge and the groove being formed along a length of the inner surface of the pinion and extending to the end face;
moving the pinion in a first direction along the output shaft;
moving the particles in the first direction for a predetermined distance as the pinion moves along the output shaft;
moving the pinion in a second direction opposite the first direction along the output shaft; and
releasing contact of the particles.

30. The method of claim 29 further comprising:
contacting the particles with the primary edge as the pinion moves along the output shaft in the first direction; and
receiving the particles in the groove as the pinion moves in the first direction.

31. The method of claim 29 further comprising:
providing a secondary edge for secondarily moving the particles away from the primary edge upon a subsequent engine start-up, the secondary edge being radially formed on the end face adjacent the primary edge.

32. The method of claim 31 further comprising:
contacting the particles with the secondary edge upon a subsequent engine start-up; and
moving the particles with the secondary edge further along the shaft to the predetermined distance as the pinion moves in the first direction.

33. The method of claim 29 wherein the particles are rotationally and linearly moved in the first direction.
